(19) United States
(12) Patent Application Publication
(10) Pub. No.: US 2007/0256339 A1
(43) Pub. Date: Nov. 8, 2007

(54) Ambient Light Sensor

(75) Inventors: Christopher James Newton Fryer, Cambridgeshire (GB); Richard Guy Blakesley, Cambridge (GB)

Correspondence Address: SUTHERLAND ASBILL & BRENNAN LLP, 999 PEACHTREE STREET, N.E., ATLANTA, GA, 30309, US

(73) Assignee: PELIKON LIMITED, Caerphilly (UK)

(21) Appl. No.: 10/597,709

(22) PCT Filed: Feb. 7, 2005
(86) PCT No.: PCT/GB05/00419

§ 371 Date: Apr. 5, 2007

(30) Foreign Application Priority Data
Feb. 6, 2004 (GB) 0402640.7

(51) Int. Cl. G09G 3/32

(52) U.S. Cl. 40/442

(57) ABSTRACT

A light-emitting display having display areas (14), which may be lit or unlit, comprising a sensor (13) for ambient light, in which the display is arranged to use an output of the sensor (13) to modify the brightness of the display areas (14) when lit in dependence upon the ambient tight conditions, the sensor being hidden behind an unlightable section of the display. The display is particularly advantageously an electroluminescent display.

This invention is concerned with improved displays, and relates in particular to displays, such as electroluminescent displays, that employ an ambient light sensor used to allow their brightness and contrast to be adjusted in dependence upon the ambient light conditions.

Certain materials are electroluminescent—that is, they emit light, and so glow, when an electric field is generated across them. The first known electroluminescent materials were inorganic particulate substances such as zinc sulphide, while more recently-found electroluminescent materials include a number of small-molecule organic emitters known as organic LEDs (OLEDs) and some plastics—synthetic organic polymeric substances—known as light-emitting polymers (LEPs). Inorganic particulates, in a doped and encapsulated form, are still in use, particularly when mixed into a binder and applied to a substrate surface as a relatively thick layer; LEPs can be used both as particulate materials in a binder matrix or, with some advantages, on their own as a relatively thin continuous film.

This electroluminescent effect has been used in the construction of displays. In some types of these a large area of an electroluminescent material—generally referred to in this context as a phosphor—is provided to form a backlight which can be seen through a mask that defines whatever characters the display is to show. In other types there are instead individual small areas of EL material. These displays have many applications; examples are a simple digital time and date display (to be used in a watch or clock), a mobile phone display, the control panel of a household device (such as a dishwasher or washing machine), and a hand-holdable remote controller (for a television, video or DVD player, a digibox, or a stereo or music centre).

The visibility of electroluminescent displays is dependent upon the contrast between those areas of the display that are turned on (“lit”) and those that are not; this contrast is the result of the lit areas being both brighter than the surrounding areas (“Iluminance contrast”) and often also a different colour (“chrominance contrast”). The brightness and colour of the lit areas is a function of the particular electroluminescent material being utilised and of the degree to which it is energised. The brightness and colour of the unlit areas is dependent on the light reflected off their surface, which in turn is a function of the ambient light level and the materials used to make up the display (which might include filters and anti-reflective coatings).

Many displays—television remote controllers, for example—are used in a wide range of ambient light levels. As the ambient light level increases, so the amount of light reflected from the off-state areas increases—and hence the luminance contrast decreases for a fixed brightness emitted by the on-state. While setting the display brightness such that it is visible in the highest expected ambient light level will mean that it can be seen in all expected ambient light levels, this has the disadvantages of increased power consumption and shorter display lifetime. Also, in some dark usage conditions the display can appear excessively bright and distracting. The invention proposes dealing with this problem by building in to the display a sensor for the ambient light, and then using the sensor's output to modify the lit areas' brightness appropriately (so that those areas are brighter in strong ambient light and of reduced brightness in weak ambient light).

In one aspect, therefore, this invention provides a light-emitting display wherein there is the necessity for a clear contrast between the display's lit and unlit areas, which display incorporates a sensor for the ambient light, and the sensor's output is utilised to modify the lit areas' brightness appropriately in dependence upon the ambient light conditions.

The light-emitting display can be of any sort—it could, for instance, be a light-emitting diode (LED) display, or it could be a backlit liquid crystal display (an LCD) or even a thin film transistor (TFT) display as used in computer screens—but the invention is of particular value when applied to displays using electroluminescent materials to provide the light output.

The light sensor may take any convenient form, and be of any suitable type. It may, for example, be a light-dependent resistor (such as the VT935G from PerkinElmer Optoelectronics) or a photodiode (such as the BPW21 from Centronic).

The sensor's output may be utilised to modify the lit areas' brightness in any appropriate fashion. For example, most modern displays incorporate a display controller—basically a single chip computer programmable to achieve the desired ends—which determines what the display is showing, and how bright it is, and most conveniently the sensor's output is simply fed to the controller and used thereby as one factor in determining the required display brightness. Typically the controller uses the sensor-supplied measure of the ambient light level A to adjust automatically the display brightness (as the ambient light level changes) according to a chosen function f(A) (where f(A) increases as A increases; f(A) can be a calculable mathematical function, or it can actually be a look-up table holding a range of pre-calculated values appropriate to the expected range of ambient light levels A). In this way the perceived display contrast can be kept approximately constant across a range of ambient light levels, making the appearance of the display more consistent, and so significantly improving the perceived quality of the display. And, of course, by allowing the light output to be kept low in low ambient light levels the display's power consumption can be greatly reduced, and its lifetime significantly extended.

Though in principle the sensor can be placed almost anywhere within (or even adjacent) the display, nevertheless for best performance the sensitive area of the light sensor should be both within the bounds of the display and in the same plane as the display surface, so that directional incident light effects are correctly compensated.

Generally, displays take the form of panels having lightable areas spaced by unlightable areas. Most conveniently the sensor is mounted directly behind, and hidden by, one such unlightable—unused—area of the display panel (many sensors will give an acceptable performance even when measuring the ambient light through a number of display layers, such as filters, transparent conductors and dielectric layers).

By behind, we may mean at an opposite side of the panel from that through which light is emitted.

Where the display utilises a (programmable) display controller, to which the sensor's output is supplied, the display controller software may also allow the controller to ignore short-term drops in the measured ambient light level, thus preventing the display from going dim if, say, the User accidentally obscures the sensor whilst using the display.

The controller can include a facility for the User to adjust the display brightness to achieve a preferred contrast in a given ambient light level, by means of buttons or other User input. The controller can then automatically scale the brightness as before to maintain this apparent contrast as the ambient light changes.

According to a second aspect of the invention, there is provided a method of controlling a light-emitting display comprising a panel having display areas, which may be lit or unlit, and unlightable areas, the method comprising the steps of measuring ambient light conditions using a sensor mounted behind the panel, and controlling the brightness of the display areas when lit in dependence upon the measured ambient light conditions.

The perceived intensity of the display may be kept substantially constant across a range of ambient light levels.

The method may also include the steps of determining which display areas and lit and unlit and determining the brightness of the display dependent thereon.

The method may use the ambient light conditions to adjust the brightness of the display according to a chosen function which increases with the measured ambient light level, the function being a mathematical function or a look-up table holding a range of pre-calculated values appropriate to an expected range of ambient light levels.

The method may ignore short-term drops in measured light level.

The method may further comprising the step of scaling the brightness to maintain the apparent contrast as the ambient light changes, in line with the setting of a preferred contrast facility.

An embodiment of the invention is now described, though by way of illustration only, with reference to the accompanying diagrammatic Drawings in which:

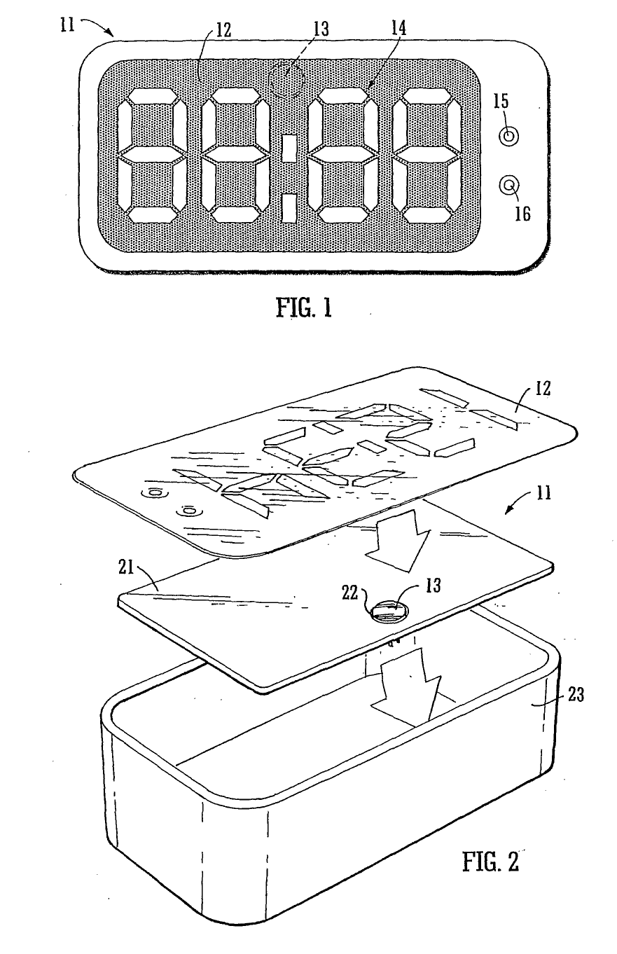

FIG. 1 shows a simple clock-type product utilising an ambient light sensor in accordance with the invention;

FIG. 2 shows the same sort of product as shown in FIG. 1, but “exploded” into its main components.

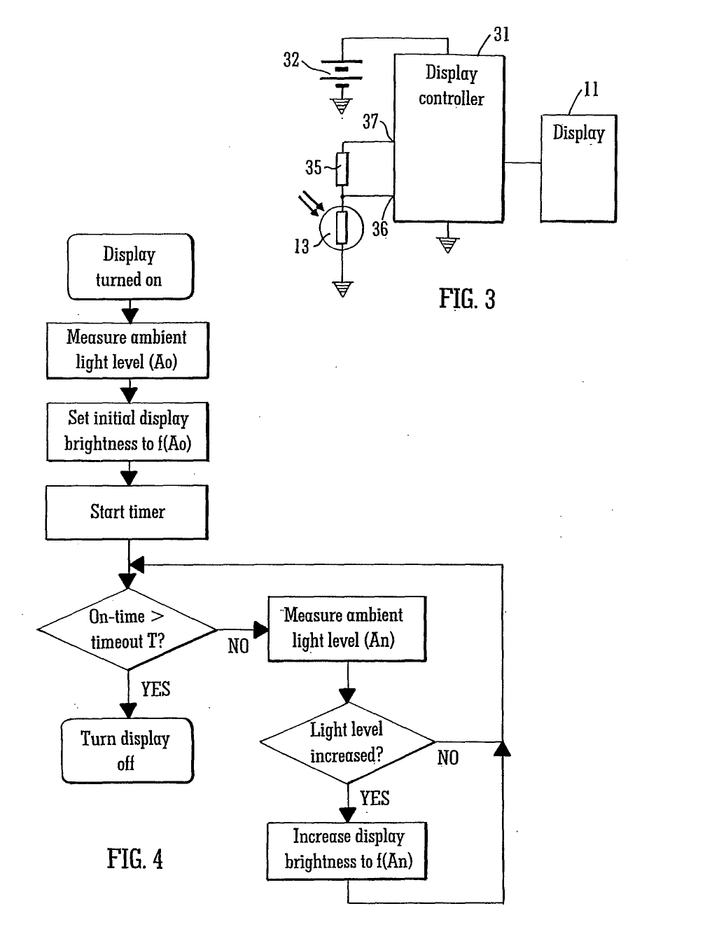

FIG. 3 shows a circuit diagram for a display product as in FIGS. 1 and 2; and

FIG. 4 shows a software flow diagram for a product as in the previous Figures.

FIG. 1 is an example configuration for a simple clock-type product. It is a clock (generally 11) in which the time is indicated by a standard 7-segment digital display (12). A light sensor (13) is mounted behind the display facing forwards, hidden by one or more layers of the display construction (e.g. filters and dielectric layers) but not obscured by the display segments (14). Buttons (15) and (16) allow the User to control the apparent display brightness.

In the “exploded” view of FIG. 2 the display 12 is mounted in front of a printed circuit board (PCB; 21). None of the PCB's components are shown here except the sensor 13, which is mounted on the reverse of the board 21 “looking” through an aperture (22) therein. The display 12 and PCB 21 are, in use mounted within a simple box-like container (23).

In FIG. 3 is shown a circuit diagram using as the ambient light sensor a light dependent resistor (13).

The relevant parts of the system comprise a display controller (31) connected to a power source (32), a display (12: such as the one shown in FIG. 1) and an ambient light sensor (13). In this case the sensor is a light dependent resistor (LDR), which is connected to a fixed resistor (35) and an analogue controller input (36). The other terminal of the fixed resistor 35 is connected to an “lenable” output (37) of the display controller 31.

When the display controller 31 wishes to measure the ambient light level, it drives the “enable” output 37 high. Current then flows through the fixed resistor 35 and the sensor LDR 13. The ambient light level affects the resistance of the LDR 13, and hence the voltage measured at the analogue input 36. The controller 31 then sets the brightness of the display 12 according to the required function f(A) of ambient light level A (in the case of an electroluminescent display, increasing the voltage and/or frequency of the drive waveforms applied to the display as A increases). The “enable” output 37 can be driven low (or alternatively high impedance) to minimise current consumption between measurements.

The flow diagram of FIG. 4 is a software flow diagram for a product that is used intermittently with automatic display switch-off (for example, a domestic television remote control) having an electroluminescent display. Though the flow diagram speaks for itself, its application can perhaps be better understood from the following description.

When the display is turned on, the initial ambient light level (A₀) is measured, and the display brightness set to f(A₀). In many products the electroluminescent display is turned off when the product is not in use, to conserve power and extend the display lifetime. The display may be turned off automatically after a timeout period T, typically a few seconds.

While the display is on, the current ambient light level (Aₙ) is measured at regular intervals (typically, every 100 ms). The display brightness is set to f(Aₙ) if the last measurement (Aₙ) is greater than the previous measurement (Aₙ₋₁). This provides a simple method to prevent the display from flickering due to measurement noise and from dimming if the User accidentally obstructs the light sensor.

For displays that are on for longer periods, it may be better to compare the current ambient light value (Aₙ) with the initial light level (A₀), thus allowing the display to dim again after brief periods of bright illumination.

We claim:

1. A light-emitting display comprising a panel having display areas, which may be lit or unlit, and unlightable areas, and comprising a sensor for ambient light, in which the display is arranged to use an output of the sensor to modify the brightness of the display areas when lit in dependence upon the ambient light conditions, and in which the sensor is mounted behind and is hidden by an unlightable area of the panel.

2. A light-emitting display according to claim 1, in which the display is an electroluminescent display.

3. A light-emitting display according to claim 1, in which the display is arranged to keep the perceived intensity of the display substantially constant across a range of ambient light levels.

4. A light-emitting display according to claim 1, comprising a display controller which determines what the display is showing, and how bright it is, in which the output of the sensor is connected to the controller.

5. A light-emitting display according to claim 4, in which the controller is arranged use the output of the sensor to adjust the brightness of the display according to a chosen function which increases with the measured ambient light level, the function being a mathematical function or a look-up table holding a range of pre-calculated values appropriate to an expected range of ambient light levels.

6. A light-emitting display according to claim 1, in which the display is arranged to ignore short-term drops in measured light level.

7. A light-emitting display according to claim 1, in which the display comprises a preferred contrast facility by means of which a user can set a desired contrast level, the display being arranged to scale the brightness to maintain the apparent contrast as the ambient light changes.

8. A light-emitting display according to claim 1, in which the sensor is mounted within the bounds of the display panel and in the same plane.

9. A method of controlling a light-emitting display comprising a panel having display areas, which may be lit or unlit, and unlightable areas, the method comprising the steps of measuring ambient light conditions using a sensor mounted behind the panel, and controlling the brightness of the display areas when lit in dependence upon the measured ambient light conditions.

10. The method of claim 9, further comprising keeping the perceived intensity of the display substantially constant across a range of ambient light levels.

11. The method of claim 9, further comprising the step of determining which display areas and lit and unlit and determining the brightness of the display dependent thereon.

12. The method of claim 9, further comprising using the ambient light conditions to adjust the brightness of the display according to a chosen function which increases with the measured ambient light level, the function being a mathematical function or a look-up table holding a range of precalculated values appropriate to an expected range of ambient light levels.

13. The method of claim 9, in which short-term drops in measured light level are ignored.

14. The method of claim 9, further comprising the step of scaling the brightness to maintain the apparent contrast as the ambient light changes, in line with the setting of a preferred contrast facility.
